(19) United States
(12) Patent Application Publication
(10) Pub. No.: US 2005/0217164 A1
(43) Pub. Date: Oct. 6, 2005

(54) Fishing reel spool

(76) Inventor: Zhong Jie, Lianyungang (CN)

Correspondence Address: TODD A. VAUGHN;BRENEMAN & GEORGES, 3150 COMMONWEALTH AVENUE, ALEXANDRIA, VA, 22305, US

(21) Appl. No.: 10/868,846

(22) Filed: Jun. 17, 2004

(30) Foreign Application Priority Data
Mar. 31, 2004 (CN) CH 2004200260176

(51) Int. Cl. A01K 87/00

(52) U.S. Cl. 43/25

(57) ABSTRACT

A fishing reel spool including a spool section for receiving a length of fishing line, the spool section including a tensioning mechanism with a pair of bias mechanisms for applying a biasing force to the spool section which results in the application of tension to the fishing line as the fishing line is wound on said spool section, and an attachment section for releaseably attaching the fishing line spool to a fishing pole, the attachment section including an upper portion and a lower portion rotateably moveable relative to the upper portion to thereby form a releasable connection, the releasable connection resulting in the formation of a channel sized to receive the fishing rod.

### BACKGROUND OF THE INVENTION

1. Field of the Invention

The invention relates generally to a fishing tackle accessory, in particular, a fishing reel spool having an improved design that increases the line tension when placing a new fishing line on the spool.

2. Description of the Related Art

The conventional technique uses a normal spool for the purpose to wind fishing lines on fishing reels. Because the fishing line deteriorates over time, to replace the old reel with a new reel, users of the fishing line must remove the old line from the reel and place the new line thereon by guiding the new line onto the reel and gradually winding the reel.

However, during the process of replacing an old fishing line with a new fishing line, it is difficult to control line tension, which may end up messy with the line being entangled and knotted up. Consequently, replacing old fishing lines is tedious, time consuming and may result in wasting lines due to entanglement.

### SUMMARY OF THE INVENTION

Accordingly, it is an object of the invention to provide a fishing reel spool that eliminates the problems faced when replacing old fishing lines on fishing reels with new fishing lines.

It is another object of the invention to provide such a fishing reel spool that solves the existing technical problems in conventional designs by using a tightening mechanism that facilitates the attachment of the spool on a fishing rod and includes a catch member on an upper clip portion and a plurality of protruding ribs on a lower clip portion which is rotatable relative to the upper clip portion. The clip portions each configured to form an interlocking connection when the lower clip portion is rotated towards the upper clip portion.

The invention aims to resolve the technical inadequacy of the conventional manner in which old fishing lines are replaced by controlling line tension. Particularly, the fishing reel spool in accordance with the invention increases line tension, thus making the process of replacing an old fishing line with a new line easier and more efficient.

The fishing reel spool in accordance with the invention accomplishes these and other objects by having a generally cylindrical spool body for receiving a length of fishing line, a spool arm sized to receive the spool body via a longitudinal shaft which extends perpendicularly relative to the spool arm. The shaft includes a catch mechanism provided at a distal end thereof for the locking spool onto the spool arm to thereby restrict the outward lateral movement way from the spool body relative to the arm.

A biasing mechanism in the form of a spring washer is provided for facilitating an increase in line tension when placing a new fishing line on the spool body. The spring washer is positioned on the shaft so that it is situated between the spool body and the spool arm to outwardly bias the spool body against the catch mechanism. Another embodiment of the invention includes a second spring washer concentrically positioned within shaft to thereby create a spring-loaded shaft.

The second spool section includes a rod clip to which the spool arm is affixed. The Fod clip includes a lower clip portion and an upper clip portion that when joined together form a channel sized to receive a fishing rod. The size of the channel is adjustable in accordance with the rod size. Any tightening, fastening or clipping designs in the conventional design can be used in accordance with the invention provided it holds the clips firmly together. The lower clip portion is rotatably moveable relative to the upper clip portion to thereby form a releasable connection therewith when the lower clip portion is manipulated.

A tightening mechanism is provided on the lower and upper clips portions. This tightening mechanism includes an arm portion which extends downwardly from the upper clip portion and has a plane which extends substantially parallel relative to the plane of the outward face of the spool body. A latch or catch member extends substantially perpendicular from the arm, and a plurality of rib extension members extends downwardly from the lower clip portion and substantially parallel to the catch member. The catch member and the rib extensions are configured to interlock firmly together upon manipulating the lower clip portion towards the upper clip portion.

When using the fishing line spool in accordance with the invention to replace an old fishing line on the fishing reel with a new fishing line, the user must open the tightening mechanism by manipulating the lower clip portion clockwise relative to the upper clip portion, then insert the rod in the open channel between the clip portions. Next, adjust the position according to the rod diameter & the clip channel diameter. Then lock the first tightening device to lock the new fishing line spool onto the rod.

Finally, guide the line from the spool to the line winder on fishing reel. Due to the shaft being loaded with a plug, this creates tension on the line. When spool on the shaft rotates, due to line tension, the fishing line will not entangle/mess up during changing, speeding up the process.

### BRIEF DESCRIPTION OF THE DRAWINGS

The advantages of the invention will become more apparent to those skilled in the art in conjunction with the detailed description of the preferred embodiments of the invention, in which:

FIG. 1 is a side planar view of a fishing line spool in accordance with the invention;

FIG. 2 is a side planar view of an unlocked fishing line spool of FIG. 1; and

FIG. 3 is a side planar view of an unlocked fishing line spool in accordance with the invention.

### DETAILED DESCRIPTION OF THE INVENTION

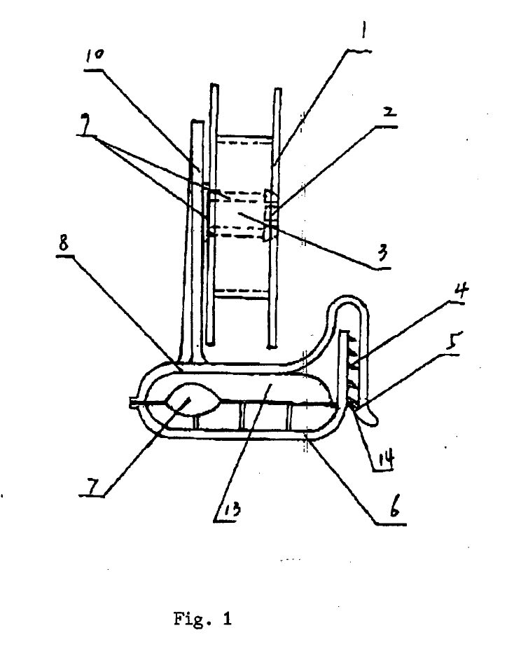

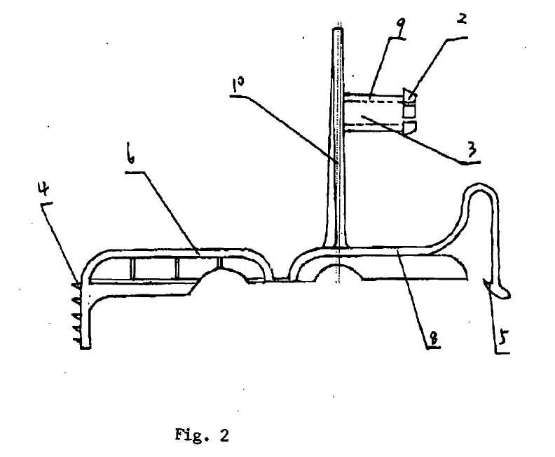

Referring now to drawing FIGS. 1 and 2, which show in an embodiment of the invention, a fishing line spool that includes a first section for receiving a length of fishing line and a second section for attachment to a fishing pole.

The first spool section includes generally cylindrical spool 1 body for receiving a length of wire used for fishing, spool arm 10 sized to receive spool 1 via longitudinal shaft 3 which extends perpendicularly relative to spool arm 10. Shaft 3 includes catch mechanism 2 provided at a distal end thereof for locking spool 1 onto arm 10 and thereby restrict the lateral movement of spool body 1 relative to arm 10.

Spring washer 9 is provided for facilitating an increase in line tension when placing a new line on spool body 1. Spring washer 9 is provided on shaft 3 so as to be situated between spool body 1 and spool arm 10 and outwardly bias spool body 1 against catch mechanism 2. Another embodiment of the invention may include second spring washer 9 concentrically positioned within shaft 3 to thereby create a spring-loaded shaft 3.

The second spool section includes rod clip 13 to which spool arm 10 is fixed. Rod clip 13 includes lower clip 6 and upper clip 8 that, when joined together form channel 7 therebetween sized to receive a fishing rod (not shown). Lower clip portion 6 is moveable relative to upper clip portion 8 to thereby form a releasable connection with upper clip portion 8 by manipulating lower clip portion 6 in an anti-clock wise direction.

Tightening mechanism 14 is provided on lower and upper clips 6, 8. First tightening mechanism 14 includes an arm extending downwardly from upper clip 8 and substantially parallel to the outward face of spool 1, latch or catch member 5 which extends substantially perpendicular from arm, and a plurality of rib extension members 4 extending downwardly from lower clip 8 and substantially parallel to catch member 5. Preferably there are five rib extensions 4. Catch member 5 and rib extensions 4 are configured to interlock firmly together upon manipulating lower clip 6 towards upper clip 8 in an anti-lockwise direction.

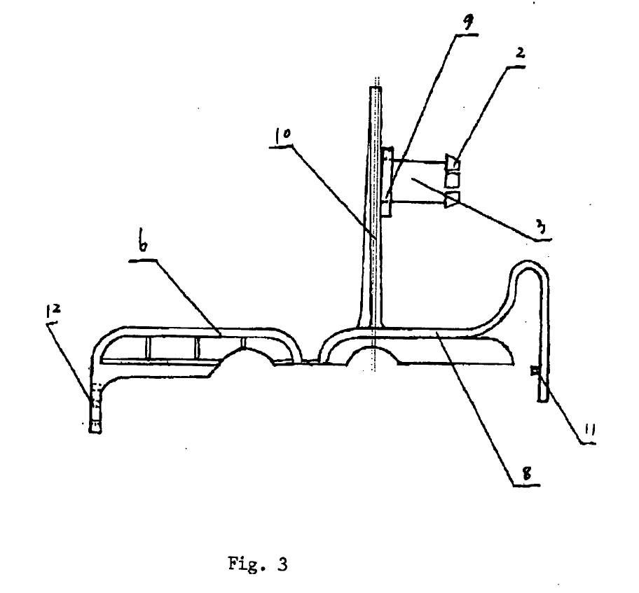

Referring now to drawing FIG. 3., which shows the spool illustrated in FIGS. 1 and 2 except this embodiment includes a second tightening device 14 having lug 11 on upper clip 8 which longitudinally protrudes perpendicular relative thereto and which is sized for receipt into one of a plurality of grooves 12 on lower clip 6 to form a interlocking connection between lower clip 6 and upper clip 8. Preferably three grooves are provided on lower clip 6. Spring washer 9 is put in between the spool 1 and spool arm 10, and a second spring washer 9 may be concentrically placed within shaft 3 to create a spring-loaded shaft 9.

The size of channel 7 can be adjusted according to the rod size. Any tightening, fastening or clipping designs in the conventional design can be used in accordance with the invention provided it holds the clips firmly together.

The fishing reel spool in accordance with the invention is advantageous over conventional designs by providing a spring washer loaded on the shaft and placing the spool on the shaft and on top of the spring washer.

The fishing reel spool in accordance with the invention is advantageous over conventional designs by providing a first spring washer positioned between the spool and spool arm and a second spring washer loaded on the shaft.

In comparison to the conventional designs, the fishing reel spool in accordance with the invention increases the tension of the fishing line when replacing an old fishing line from the reel (line winder) with a new fishing line. This results in a convenient, speedy process that does not cause entangled/messy fishing lines when inserting a new fishing line.

To protect against damage, it is preferred that the fishing reel spool in accordance with the invention is composed of high quality materials having certain elastic properties. Such a fishing reel spool is adaptable for single or multiple uses.

It is apparent that innumerable variations of the preferred embodiments described hereinbefore may be utilized. However, these as well as other variations are believed to fall within the spirit and scope of the invention as covered by the claims attached herein.

1-5. (canceled)

6. A fishing line spool comprising:
a spool body for receiving a length of fishing line;
a spool arm configured to receive said spool body, said spool arm having an elongated shaft extending perpendicularly therefrom and upon which said spool body sits, said shaft having at a distal end thereof a catch mechanism for locking said spool body to said spool arm;
a tensioning mechanism for providing a biasing force to said spool body which results in tension being applied to the fishing line as the fishing line is wound on said spool body; and
a rod clip attached to said spool arm for locking said fishing line spool to a fishing rod, said rod clip including an upper clip portion and a lower clip portion rotateably moveable relative to said upper clip portion to thereby form a releasable connection therebetween, said releasable connection resulting in the formation of a channel sized to receive the fishing rod.

7. The fishing line spool of claim 6, wherein said tensioning mechanism comprises a spring washer concentrically placed on said shaft so as to rest between said spool arm and said spool body.

8. The fishing line spool of claim 6, wherein said tensioning mechanism comprises a first spring washer concentrically placed on said shaft so as to rest between said spool arm and said spool body and a second spring washer placed concentrically within said shaft to extend perpendicularly relative to said spool arm.

9. The fishing line spool of claim 6, wherein said rod clip includes a tightening mechanism configured to adjust the size of said channel to facilitate the receipt of fishing rods of various sizes.

10. The fishing line spool of claim 6, wherein said tightening mechanism includes a latch member provided on said upper clip portion and a plurality of rib extensions protruding from said lower clip portion, said latch member engaging one of said rib extensions to form an interlocking connection when said lower clip portion is pivoted anti-clockwise towards said upper clip portion.

11. The fishing line spool of claim 10, wherein said plurality of rib extensions comprises five rib extensions.

12. The fishing line spool of claim 6, wherein said tightening mechanism includes a lug member provided on said upper clip portion and a plurality of grooves on said lower clip portion sized to receive said lug member to form an interlocking connection when said lower clip portion is pivoted anti-clockwise towards said upper clip portion.

13. The fishing line spool of claim 12, wherein said plurality of grooves comprises three grooves.

14. A fishing line spool comprising:
a generally cylindrical body for receiving a length of fishing line;
a spool support member having an elongated shaft extending perpendicularly therefrom and upon which said body is concentrically received, said shaft having at a distal end thereof a catch mechanism for locking said body to said spool support member;
a first spring washer concentrically received on said shaft for applying a biasing force to said spool support member which results in the application of tension to the fishing line;
a second spring washer concentrically received within said shaft for applying a biasing force to said spool support member which results in the application of tension to the fishing line; and
a rod clip attached to said spool arm for locking said fishing line spool to a fishing rod, said rod clip including an upper clip portion and a lower clip portion rotatably moveable relative to said upper clip portion to thereby form an interlocking connection, said interlocking connection resulting in the formation of a channel sized to receive the fishing rod.

15. A fishing line spool comprising:
a spool section for receiving a length of fishing line, said spool section including a tensioning mechanism having a pair of bias mechanisms for applying a biasing force to said spool section which results in the application of tension to the fishing line; and
an attachment section for attaching said fishing line spool to a fishing pole, said attachment section including an upper portion and a lower portion rotatably moveable relative to said upper portion to thereby form a releasable connection, said releasable connection resulting in the formation of a channel sized to receive the fishing rod.

16. The fishing line spool of claim 15, wherein said spool section further comprises an support arm and an elongated shaft extending perpendicularly therefrom upon which a spool body is concentrically received.

17. The fishing line spool of claim 16, wherein said shaft has at a distal end thereof a catch mechanism for locking said spool body to said arm member.

18. The fishing line spool of claim 17, wherein said biasing mechanisms comprise first and second spring washers.

19. The fishing line spool of claim 18, wherein said first spring washer is concentrically received on said shaft so as to rest between said support arm and said spool body.

20. The fishing line spool of claim 19, wherein said second spring washer is concentrically received within said shaft.

21. The fishing line spool of claim 15, wherein said attachment section further comprises a latch member provided on said upper portion and a plurality of rib extensions provided on said lower portion to engage said latch member to form an interlocking connection when said lower portion is pivoted anti-lockwise towards said upper portion.

22. The fishing line spool of claim 21, wherein said plurality of rib extensions comprises five rib extensions.

23. The fishing line spool of claim 15, wherein said attachment section further comprises a lug member provided on said upper portion and a plurality of grooves provided on said lower portion sized to receive said lug member to form an interlocking connection when said lower clip portion is pivoted anti-clockwise towards said upper clip portion.

24. The fishing line spool of claim 23, wherein said plurality of grooves comprises three grooves.
